(19) United States
(12) Patent Application Publication
(10) Pub. No.: US 2013/0117040 A1
(43) Pub. Date: May 9, 2013

(54) Method and System for Supporting a Health Regimen

(71) Applicant: OMADA HEALTH, INC., San Francisco, CA (US)

(72) Inventors: Adrian Benton James, Oakland, CA (US); Andrew Paul DiMichele, San Francisco, CA (US); Sean Patrick Duffy, San Francisco, CA (US)

(73) Assignee: OMADA HEALTH, INC., San Francisco, CA (US)

(21) Appl. No.: 13/668,644

(22) Filed: Nov. 5, 2012

Related U.S. Application Data
(60) Provisional application No. 61/555,455, filed on Nov. 3, 2011.

(51) Int. Cl. G06Q 50/22

(52) U.S. Cl. 705/2

(57) ABSTRACT

A method and user interface for supporting a health regimen comprising: grouping a plurality of participants into a matched group; providing, to each participant of the matched group, a body metric measurement device configured to communicate remotely with a network; receiving a set of body metric measurement data over the network from the participant and a portion of the participants of the matched group; storing the set of body metric measurement data on a server; determining a trend in the body metric measurement of the participant; determining a trend in the body metric measurement of the portion of the matched group; providing feedback to the participant based on the trend of the participant relative to the trend of the portion of the matched group; providing, to each participant of the matched group, a health regimen curriculum; and providing a physical motivational incentive to the participant.

### CROSS-REFERENCE TO RELATED APPLICATIONS

This application claims the benefit of U.S. Provisional Application No. 61/555,455, titled “Method and User Interface for Supporting a Health Regimen” filed on Nov. 3, 2011, which is incorporated in its entirety by this reference.

### FIELD

This invention relates generally to the medical field, and more specifically to an improved method for supporting a health regimen in the medical field.

### BACKGROUND

It is well known that people with excess body weight (e.g. body fat) have increased risk of health problems, such as diabetes and cardiovascular disease. Medical professionals generally advise overweight or obese patients to lower their risk of health complications by losing excess weight. For example, people with pre-diabetes (a condition in which glucose levels are higher than normal but are not high enough for a diagnosis of diabetes) can delay or lower their risk of developing diabetes by losing a modest amount of weight through dietary changes and increased physical activity. However, despite general guidelines such as improved diet or increased exercise, it may be difficult for many to effectively lose weight. Generic guidelines may not be suitable or useful for certain individuals, and many may not have access to personal nutritionists or trainers. Drastic lifestyle changes are often difficult to implement, and may contribute to lost motivation that hampers effective weight loss. Thus, there is a need in the medical field to create an improved method and user interface for supporting a health regimen. This invention provides such an improved method, system, and user interface.

### BRIEF DESCRIPTION OF THE FIGURES

FIGS. 1 and 2 are schematics of an embodiment of a method for supporting a health regimen of a preferred embodiment;

FIG. 3 is a schematic of an example of filtering measurement data in the method of a preferred embodiment;

FIGS. 4A and 4B are examples of determining trends of the body metric measurements of a participant and of a matched group;

FIG. 5A depicts an embodiment of a user interface for supporting a health regimen;

FIG. 5B is an example of a home page in an example embodiment of a user interface for supporting a health regimen;

FIG. 6 is an example of a profile page in an example embodiment of a user interface for supporting a health regimen;

FIG. 7 is an example of a progress page in an example embodiment of a user interface for supporting a health regimen;

FIG. 8 is an example group page in an example embodiment of a user interface for supporting a health regimen;

FIGS. 9A and 9B are example communications between participants in an example embodiment of a user interface comprising a message client;

FIG. 10 is an example curriculum page in an example embodiment of a user interface for supporting a health regimen;

FIG. 11 is an example communication between a facilitator and a participant in an example embodiment of a user interface for supporting a health regimen;

FIG. 12 is a second example of a profile page in a second example embodiment of a user interface for supporting a health regimen;

FIG. 13 is a second example of a group page in a second example embodiment of a user interface for supporting a health regimen;

FIG. 14 is a second example of a curriculum page in a second example embodiment of a user interface for supporting a health regimen;

FIG. 15 is a sample health regimen curriculum scheme based on a diabetes prevention program; and

FIG. 16 depicts an embodiment of a system for supporting a health regimen.

### DESCRIPTION OF THE EMBODIMENTS

The following description of embodiments of the invention is not intended to limit the invention to these embodiments, but rather to enable any person skilled in the art to make and use this invention.

### Method for Supporting a Health Regimen

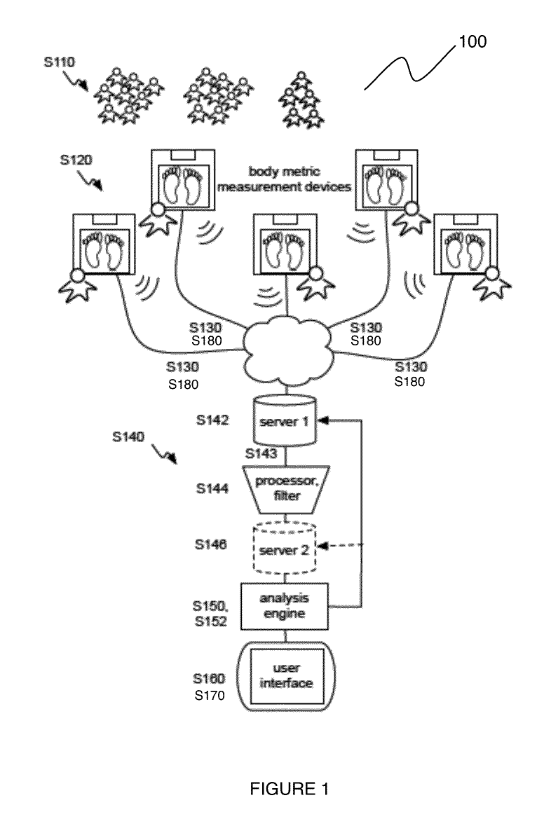

As shown in FIG. 1, in a preferred embodiment, the method 100 for supporting a health regimen includes the steps of: grouping a plurality of participants into a matched group S110; providing, to each participant of the matched group, a body metric measurement device configured to communicate remotely with a network S120, receiving a set of body metric measurement data S130 over the network from a participant and a portion of the participants of the matched group S130, storing the set of body metric measurement data S140 on a server; determining a body metric measurement trend of the participant S150, determining a body metric measurement trend of the portion of the matched group S152; and providing feedback to the participant S160 based on the body metric measurement trend of the participant relative to the body metric measurement trend of the portion of the matched group S160. The method 100 may further include providing, to each participant of the matched group, a health regimen curriculum S170, and providing a physical motivational incentive to the participant S180. A facilitator leading the matched group and/or the participants in the matched group may provide feedback and support tailored to the matched group overall and/or to individual participants in the matched group. At least some of the steps are preferably repeated through the health regimen. In particular, receiving a set of body metric measurement data S130, storing the set of body metric measurement data S140, determining a trend in the body metric measurements of the participant S150, determining a trend of in the body metric measurements of the matched group S152, and providing feedback to the participant S160 are preferably repeated cyclically, and some of these steps may be repeated multiple times within a cycle.

The method 100 is preferably used to facilitate a social environment in which the participants interact with the facilitator and/or one another to more effectively follow a health regimen. In one preferred embodiment, the method 100 is used to help guide participants diagnosed with prediabetes to lose weight to reduce their risk of developing diabetes. In particular, the method may be used to guide participants through the steps outlined in the Diabetes Prevention Program (a research study funded by the National Institute of Diabetes and Digestive and Kidney Diseases). The National Diabetes Prevention Program core curriculum, core session handouts, post-core curriculum, post-core session handouts, and additional materials (National Center for Chronic Disease Prevention and Health Promotion, Diabetes Training and Technical Assistance Center at the Rollins School of Public Health, Emory University) are incorporated herein by reference. In another embodiment, the method 100 is used to help guide participants diagnosed with obesity to lose weight through an exercise and/or diet regimen. Furthermore, in alternative embodiments the method 100 may be used to support health regimens regarding other body metrics, such as BMI, body fat percentage, blood pressure, cholesterol, or other suitable measurements. In variations of the embodiments, the method 100 may be used in a group, support-oriented setting to monitor weight loss or gain in other applications, such as to monitor rapid weight gain indicative of swelling after a diagnosis of congestive heart failure, to monitor unintended weight loss suggestive of paraneoplastic syndrome after a diagnosis of cancer (e.g., prostate or lung cancer), to monitor weight fluctuations after diagnosis of hyper- or hypothyroidism or hyper- or hypoadrenalism (which may indicate, for example, medication dosing errors or changes in the endocrine defect), or to monitor weight trends after diagnosis of eating disorders such as anorexia. In some alternative variations of the embodiments, the method 100 may omit grouping the participants into at least one matched group, such that trends and feedback are determined on an individual basis only.

Grouping a plurality of participants into a matched group S110 functions to establish a community among participants. The participants within a matched group preferably share at least one common goal related to a body metric measurement, such as losing weight, maintaining weight, gaining weight, or reducing body fat percentage, and/or a common goal related to a health condition, such as preventing development of prediabetes to diabetes. Alternatively the participants within a matched group are grouped based on another characteristic. In a preferred embodiment, a matched group includes approximately 8-16 participants, although the matched group may include any suitable number. Grouping a plurality of participants may include one or more variations that cluster participants in similar or the same groups based on various shared characteristics.

In a first variation, grouping a plurality of participants into a matched group S110 includes grouping participants based on a characteristic of a common goal. In a first example of the first variation, the participants within a matched group may share the goal of losing or gaining a certain percentage (e.g. 5%) of an individual respective starting weight or a certain number of pounds. In a second example of the first variation, the participants within a matched group may share the goal of maintaining current starting weight or to attain a particular goal weight. In other examples of the first variation, the participants within a matched group may share the goal of losing, gaining, maintaining, or attaining a particular level or amount of BMI, body fat percentage, or other body metric measurement.

In a second variation, grouping a plurality of participants into a matched group S110 includes grouping participants based on medical history. In a first example of the second variation, participants within a matched group may be diagnosed with a particular condition at approximately the same time (e.g. diagnosed with pre-diabetes within two months of one another, or another suitable threshold). In a second example of the second variation, participants within a matched group may have similar initial body weights, similar initial degree (class or stage) of congestive heart failure or other diagnosis of a cardiovascular disease. In a third example of the second variation, participants within a matched group may be diagnosed with a similar degree of obesity, and in a fourth example of the second variation, participants within a matched group may be diagnosed with a similar stage of osteoarthritis or other joint disease that affects mobility. Other aspects of medical history may be considered in matching participants, such as diagnosis of depression or obsessive-compulsive disorder.

In a third variation, grouping a plurality of participants into a matched group S110 includes grouping participants based on shared personality traits, or similar positions within a personality spectrum. In an example of the third variation, participants within a matched group may have received similar results of a personality test or other assessment. Shared personality traits may include, for instance, optimism, extroversion, openness, agreeableness, or neuroticism. Grouping participants into a matched group may include administering to the participants a standard personality test (e.g. Myers-Brigg personality test, Big Five personality test) or a customized personality test, and clustering participants into matched groups based on the results of the standard or customized personality test.

In a fourth variation, grouping a plurality of participants into a matched group S110 includes grouping participants based on a shared lifestyle characteristic or common interests. In an example of the fourth variation, participants within a matched group may have similar dietary restrictions or preferences (e.g., vegetarianism, veganism, nut-free, gluten-free), marriage status (e.g., married, divorced, widowed, single), children status (e.g. existence, age, gender, number of children), pet status (e.g. existence, age, species, number of pets), religious identification, or other suitable lifestyle characteristic. In another example of the fourth variation, the participants within a matched group may have similar hobbies or other interests (e.g. sports, television shows, cooking).

In a fifth variation, grouping participants into a matched group includes grouping participants based on personal information. In examples of the fifth variation, such personal information may include gender, ethnicity or nationality, age, current geographical area, or occupational field. As another example of the fifth variation, personal information may include hometowns, schools attended, employers, or any suitable personal information.

In additional variations, the step of grouping participants may incorporate any suitable combination of these variations and/or any suitable aspect of the participants. In some embodiments of the method, the participants may additionally and/or alternatively be grouped based on contrasting or complementary aspects, rather than all common traits. For example, participants within a matched group may include both optimists and pessimists, or extroverts and introverts. Furthermore, the step of grouping participants may include weighting one or more of the various characteristics more heavily than others in their importance in the grouping process. For example, grouping participants based on a characteristic of a common goal is preferably weighted more heavily than grouping participants based on personal information.

Grouping a plurality of participants into a matched group S110 may further include sorting the participants using a “tiered” or “staged” process that effectively places the various characteristics in a hierarchy of importance. For instance, in a first stage an initial group of participants may filtered into a second group of participants that exclusively share the goal of losing a particular percentage of their initial respective weights. In a second stage, the second group of participants may be further filtered into a third group of participants that are within a particular age range. In a third stage, the third group of participants may be further filtered into a fourth group of participants that are of the same gender. In this manner, the grouping process may include any suitable number of stages that successively reduce or sort a larger group of participants into smaller matched groups until one or more suitable matched groups are created. In another embodiment, grouping may additionally and/or alternatively include assigning each of the participants a classification or number based on the sorting characteristics and grouping the participants based on their respective classification or number. However, the sorting characteristics may be used to group participants into appropriate matched groups in any suitable manner.

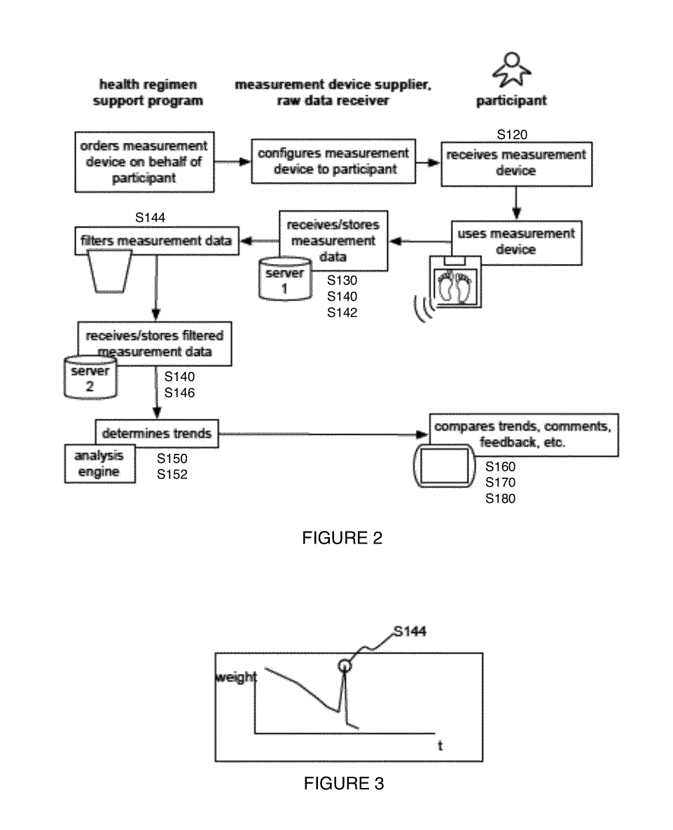

Providing, to each participant of the matched group, a body metric measurement device configured to communicate remotely with a network S120, functions to facilitate measuring a body metric of the participant and to facilitate a manner in which the participants can submit or communicate their body metric measurements (also referred to more simply as “measurements”, “measurement data”, or data points) to a server. Preferably, the body metric measurement device is a weight scale that measures the body weight of a participant. For example, the body metric measurement device may be a BodyTrace™ eScale. In alternative embodiments, the body metric measurement device may be a body fat measuring device (e.g. skinfold caliper), a sphygmomanometer that measures blood pressure, a blood glucose monitor, or any suitable body metric measuring device. Furthermore, the method 100 may further include providing multiple body metric measurement devices (e.g., a weight scale that communicates weight of the participant and a pedometer that communicates number of steps walked by the participant) to each participant of the matched group. Preferably, the body metric measurement device requires no user setup (e.g. calibration and setup performed before the user receives the device, as shown in FIG. 2), but alternatively, minimal setup by the user may be required (e.g. input of identification information prior to device activation). In some embodiments, as shown in FIG. 2, the body metric measurement device may be electronically paired or assigned to a particular participant, such as by linking a product serial number with the name of the participant and storing the link information in a database. The body metric measurement device is preferably configured to communicate over a network such that body metric measurement data may be uploaded to a remote storage, such as through cellular networks (e.g., Global System for Mobile Communications) or over the internet (e.g., Wi-Fi). As shown in FIG. 2, the body metric measurement device is preferably shipped directly to the participant or provided through a retailer, electronic ordering system, or other source to the participant. Preferably, identical models of a body metric measurement device are provided to all participants within a matched group, to maintain consistency and comparability of measurements between participants. Providing identical models of the body metric measurement device may further comprise calibrating all models provided to participants of a matched group, such that they perform consistently in relation to each other. In an alternative embodiment, the step of providing a body metric measurement device may be omitted; for example, instead of a distributor shipping the measurement device to the participants, the participants may be expected to purchase a measurement device on their own at a retailer or other source.

Receiving a set of body metric measurement data S130 over the network from the participant and a portion of the participants of the matched group functions to gather data from which to generate feedback in support of the health regimen. This step is preferably repeated over time such that a time series of body metric measurement data may be received in regular intervals (e.g., hourly, daily, weekly, biweekly) or irregular intervals from the participant and at least one other participant of the matched group. The set of body metric measurement data may further comprise multiple time series of body metric measurement data, the multiple time series of body metric measurement data comprising a time series from the participant, and a time series from each participant of the portion of the matched group. Measurements from the participant and from each participant of the portion of the matched group may be received at the same time or at different times; preferably, measurements from the participant and from each participant in the portion of the matched group are received at the same frequency and/or simultaneously. Alternatively, measurements from the participant and from each participant in the portion of the matched group are received at different frequencies and/or different instances. As described above, the multiple time series are preferably received over a network such as a Global System for Mobile Communication or Wi-Fi. Each body metric measurement in the set of body metric measurement data is preferably labeled with identifying information, such as date, time, and/or location of measurement, personal information identifying the participant being measured, and/or a serial number or other identifier of the body metric measurement device. A time series of measurements is preferably received with push technology, such that the measurement device of a participant initiates transmission of body metric measurement data. However, the time series of measurements may additionally and/or alternatively be received with pull technology, such that the receiver initiates transmission of the body metric measurement (e.g. through polling or manual initiation on the receiver side). A time series of body metric measurements may be received as individual measurements, or as packets or bundles of multiple measurements.

Storing the set of body metric measurement data S140 on a server or other database functions to create and maintain a record of received measurement data from the participant and one or more of the participants of the matched group. Storing the set of body metric measurement data S140 enables the set of body metric measurements, comprising at least one time series of data, to be shared. As shown in FIGS. 1 and 2, storing the set of body metric measurement data preferably includes storing the set of body metric measurement data on a first server S142, receiving the set of data from the first server S143, filtering the received set of data S144, and storing the filtered set of data on a second server S146 for later processing. The first server is preferably a server associated with the storing the raw body metric measurement data directly from the measurement device, as well as identifying information associated with the measurements. In an example embodiment of the method 100 using the BodyTrace™ eScale, the first server is a server dedicated to the BodyTrace™ network. A second server in the example embodiment receives body metric measurements from the first server in a manner similar to that of receiving body metric measurements from the body metric measurement devices (e.g., push or pull technology). Alternative embodiments of the method 100 may comprise storing the set of body metric measurement data on multiple servers, with additional filtering and/or receiving steps.

Storing the set of body metric measurement data S140 on a server preferably comprises filtering the received set of body metric measurement data S144, which functions to remove any suspicious measurements from the received measurement data. In particular, filtering preferably includes identifying erroneous measurements. Example erroneous measurements include measurements that are unlikely to come from a participant (e.g. measurements resulting from outsider interference), erroneous measurements due to device malfunction, erroneous measurements due to participant error, and other non-representative measurements. In one embodiment, the method 100 may further comprise detecting if an outsider has used the device (e.g. through identity verification), so as to produce an erroneous measurement. As shown in FIG. 3, identifying erroneous measurements may include analyzing for unrealistic measurement gains or losses (outliers) compared to previously determined body metric measurement trends. In a first example of filtering the received set of body metric measurement data S144, a single body metric measurement may be identified/flagged if the measurement indicates a significant weight gain of 10 pounds over one day relative to the average weight of the previous 5 days. In a second example of filtering the received set of body metric measurement data S144, any body metric measurement in the received set of body metric measurement data may be identified/flagged if the measurement deviates from an adjacent measurement by a specified amount. In a third example of filtering the received set of body metric measurement data, a line may be fitted to the set of body metric measurement data, and any measurement that has a residual (relative to the line) with an absolute value greater than a specified amount may be identified/flagged. However, any suitable analysis for filtering the received measurements may be performed. The identified/flagged measurements may be automatically removed from the data set or marked for manual review and removal from the data set. In some variations, the degree to which a flagged measurement is suspicious may affect whether the flagged measurement is automatically removed or marked for review (e.g., flagged measurements that deviate from the trend by a certain threshold amount are automatically removed from the data set).

Storing the filtered set of data on a second server S146 maintains a record of filtered measurements, such as for independent analysis (e.g. outside of the BodyTrace™ server in the example embodiment of the method 100 using the BodyTrace™ eScale). However, in an alternative embodiment, body metric measurement data may be stored in a single server, and filtering and other processing steps may be performed before or after storing the measurements on the server.

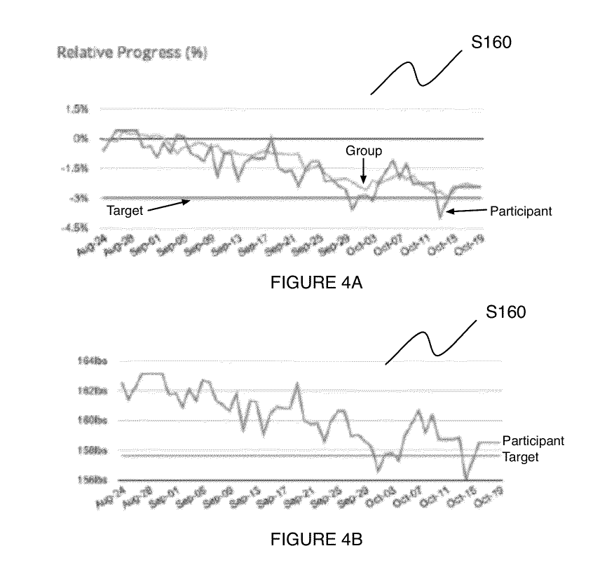

Determining a body metric measurement trend of the participant S150 functions to analyze the progress or status of the participant in the health regimen as a function of time. A determined trend is preferably subsequently stored on at least one of the servers for future use (e.g., filtering future received measurements), but alternatively, an additional server may be used to store a determined trend or a set of determined trends, each trend in the set of determined trends corresponding to a participant. Determining a body metric measurement trend of the participant S150 may include one or more of several variations: In a first variation, as shown in FIG. 4A, measurements used to determine the trend of the participant are analyzed and output as percentages relative to an initial baseline measurement. In an example of the first variation, following an initial baseline weight measurement of 200 pounds, a subsequent measurement of 195 pounds (loss of five pounds) is calculated as a data point of 2.5% loss relative to the initial baseline weight in a weight trend. Additional subsequent measurements based on the set of body metric measurement data are analyzed relative to the initial baseline weight measurement. In a second variation, as shown in FIG. 4B, measurements used to determine the trend of the participant are analyzed and output as absolute differences relative to an initial baseline measurement, similar to the first variation; however, in the second variation, measurements are expressed as absolute numbers rather than percentages. In a third variation, measurements used to determine the trend of the participant are determined as percentages relative to a previous measurement, or an averaged (e.g., mean or median) value of a certain number of previous measurements in a time series of body metric measurement data. In a fourth variation, measurements used to determine the trend of the participant are determined as absolute differences relative to one or more previous measurements, similar to the third variation; however, in the fourth variation, data points are expressed as absolute numbers rather than percentages. In a fifth variation, a line may be fitted to body metric measurements for the participant, and a rate of progress (e.g. weight loss per unit time) may be used to represent the trend of a participant.

Determining a body metric measurement trend of a portion of the matched group S152 functions to assess the progress or status of the matched group in the health regimen. Determining a trend of a portion of the matched group preferably comprises determining a trend based on a set of body metric measurement data representing all participants in the matched group or alternatively, less than all participants in the matched group. The determined trend is preferably subsequently stored on at least one of the servers for future use (e.g., filtering future received measurements), but alternatively, an additional server may be used to store a determined trend or a set of determined trends, each trend in the set of determined trends corresponding to a participant of the portion of the matched group. The trend for the portion of the matched group may be calculated in a manner similar to calculating the trend of a single participant using any suitable variation as described above, except that each measurement/data point for the portion of the matched group may be an averaged (e.g., mean or median) measurement value of all of the participants within the matched group. In a first example using averaged measurement values, a time series of body metric measurement data may be collected from each participant of the portion of the matched group, and measurements taken at similar time points (e.g. within a 24-hour period of time in a 16 week time period) may be averaged across all participants of the portion of the matched group for use in determining the trend of the matched group. In a second example using averaged measurement values, the trend of the matched group may include a different number of measurements than the number of measurements used to determine a trend in a body metric measurement of the participant S150, as measurements from the participants in the portion of the matched group may not be available for identical periods of time (e.g. measurements are received once per day from one participant and once every two days from another participant). In the second example, the trend of the matched group may include a set of measurements, each representing an average group value over a two-week period, while the trend of the participant may include a set of measurements, each measurement representing a daily value. However, both the trend of the participant and the trend of a portion of the matched group may have any suitable resolution of measurement data points. In a third example averaged measurement values, each corresponding to different time points for the portion of the matched group, may be fitted to a line, such that a rate of progress of the portion of the matched group (e.g. weight loss per unit time) may be used to represent the trend of the portion of the matched group. Preferably, the participant is a part of the portion of the matched group, such that the body metric measurement data of the participant is factored into determining the trend in the body metric measurement data of the portion of the matched group; however, alternatively, the trend in the body metric measurement of the portion of the matched group may be determined from a subset of the set of body metric measurement data, wherein the subset excludes the body metric measurement data of the participant.

Providing feedback to the participant S160 based on the trend in the body metric measurement of the participant relative to the trend in the body metric measurement of the portion of the matched group functions to use the trend in the body metric measurement of the portion of the matched group to support and motivate a participant during his or her health regimen. Preferably, the participant is a part of the matched group, such that the participant is motivated by fellow “team members” in the matched group to adhere to the health regimen. In a variation, the participant, as part of the matched group, “competes” against other matched groups as a source of support and motivation during his or her health regimen. Alternatively, the participant is not a part of the matched group, such that the participant “competes” against the matched group as a source of motivation during his or her health regimen. Preferably, feedback is provided through a user interface (described further below in more detail) communicatively coupled to at least one server that stores body metric measurements of the participants. The user interface is preferably an application accessed through a computing device, or alternatively, a website presented as a separate online social network site or online community. The user interface may alternatively be hosted by a third-party social network site. Providing feedback may include one or more of several steps as described below; however, the feedback may be provided in any suitable manner.

As shown in FIGS. 4A and 4B, providing feedback to the participant S160 preferably includes displaying the trend in the body metric measurements of the participant and/or displaying the trend in the body metric measurements of the matched group. One or both of these trends may be displayed on a profile page of the participant in a user interface. The trends are preferably displayed on charts as a function of time, with any suitable time divisions (e.g., daily, biweekly, weekly, monthly). The trends may additionally and/or alternatively be displayed as tables, bar graphs, or in any other format. In an embodiment, the method 100 follows a designated health regimen program such as the Diabetes Prevention Program, and providing feedback to the participant S160 further includes displaying individual and/or group progress in the health regimen program and metrics of any activities associated with the health regimen, such as walking (e.g. determined using a connected pedometer). Simultaneously displaying trends of a participant and of the matched group enables the participant to directly compare his or her progress and success in the health regimen with that of other participants, at least relative to the overall progress of the matched group. The overall progress of the matched group and individual progress of other participants in the matched group may be motivational to a particular participant, and are preferably relevant to a particular participant because of the nature in which the participants were sorted and grouped.

Providing feedback to the participant S160 preferably further includes enabling a facilitator associated with the matched group to access the trend of the participant and/or the trend of the portion of the matched group. Similarly, providing feedback to the participant S160 preferably further includes enabling one or more of the participants in the matched group to view a displayed trend of another participant and/or the trend of a portion of the matched group. However, providing feedback to the participant S160 may further include allowing the participant to designate privacy settings that limit the details available to other participants and/or the facilitator. For example, the participant may select settings such as to enable the facilitator and/or other participants to view a trend of his weight measurements represented in percentage of change, but to restrict the facilitator and/or other participants from viewing a trend of his/her weight measurements represented in absolute numbers.

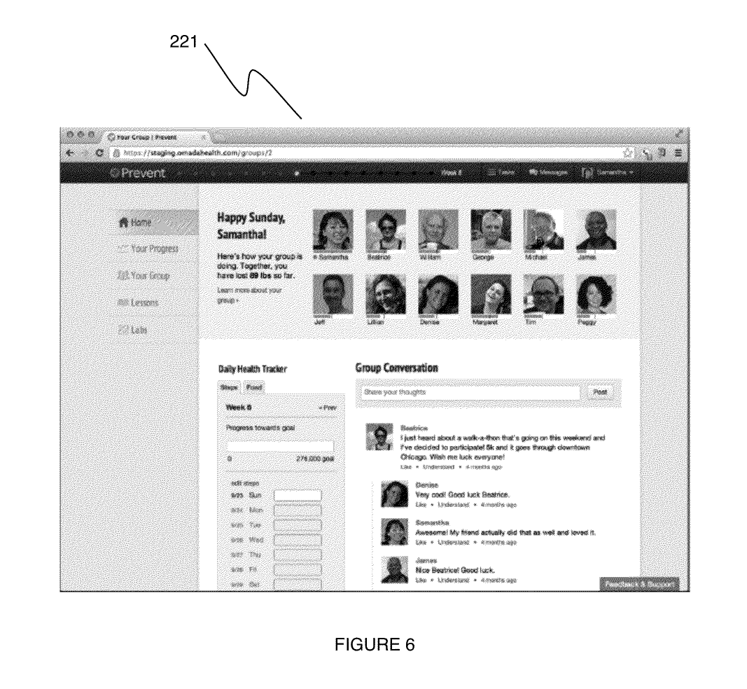

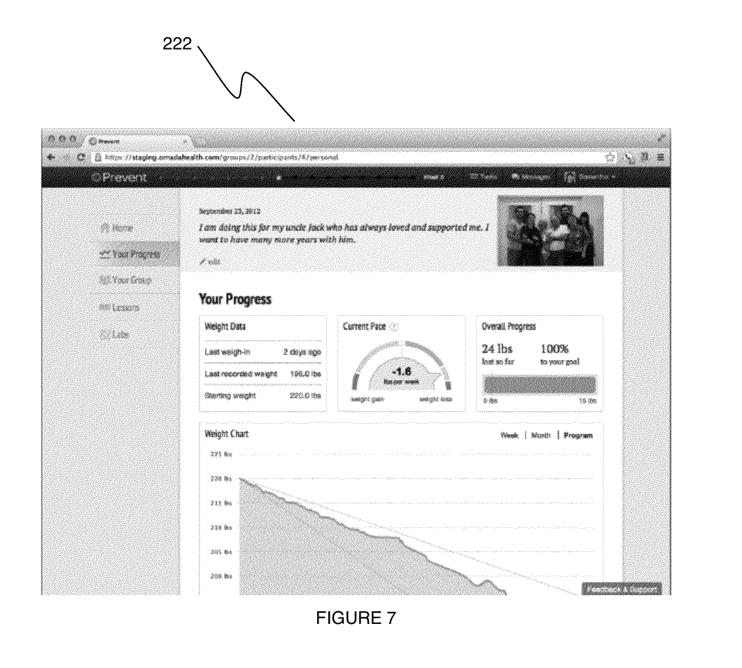

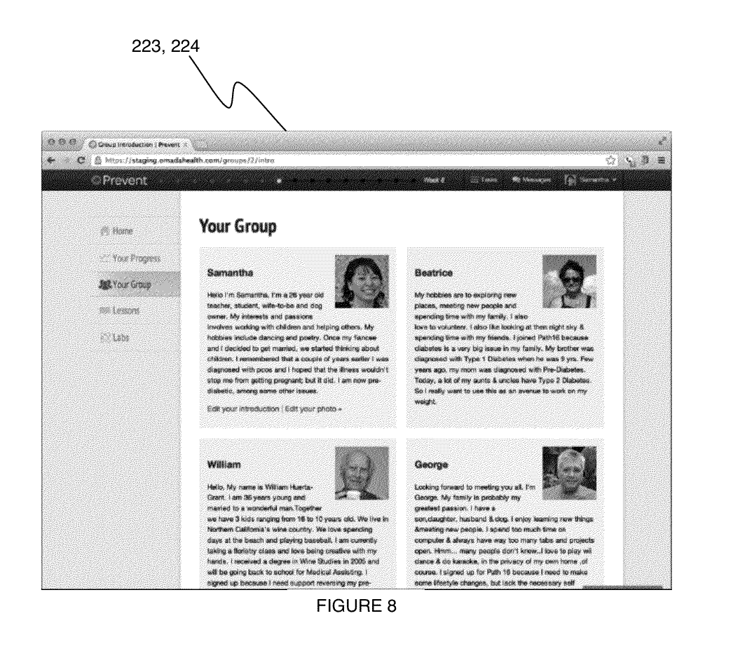

Providing feedback to the participant S160 preferably further includes enabling a facilitator associated with the matched group to provide comments to one or more of the participants in the matched group. As shown in FIG. 6, the facilitator may address general comments to the matched group on a group page of a user interface. The facilitator may additionally and/or alternatively provide targeted comments to a particular individual participant, such as by posting comments on the profile page of the participant, and/or by sending a personalized message accessible only by the individual participant and the facilitator. Similarly, providing feedback may further include enabling a participant in the matched group to provide comments to one or more of the other participants in the matched group, including general comments on the group page, targeted comments on the profile page of a particular targeted participant, and/or personalized messages accessible only by the participant and the targeted participant. Comments from the facilitator and fellow participants in the matched group serve to provide motivation and support throughout the health regimen. Such comments may include, for example, congratulatory remarks on a completed milestone, suggestions for modifications in activities (diet, exercise plan, etc.), general motivational remarks, sharing of personal stories to enhance personal connections within the matched group and/or facilitator, questions to generate discussions, invitations to perform a health regimen curriculum task socially, or any suitable comments. In some embodiments, providing feedback further includes enabling a facilitator and/or participants in the matched group to share photos or other media with another participant or the matched group in general.

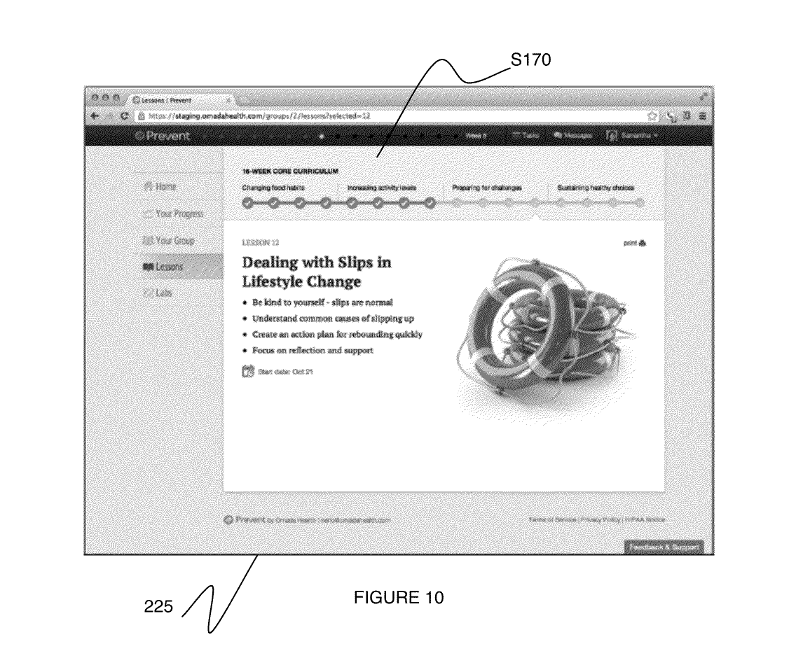

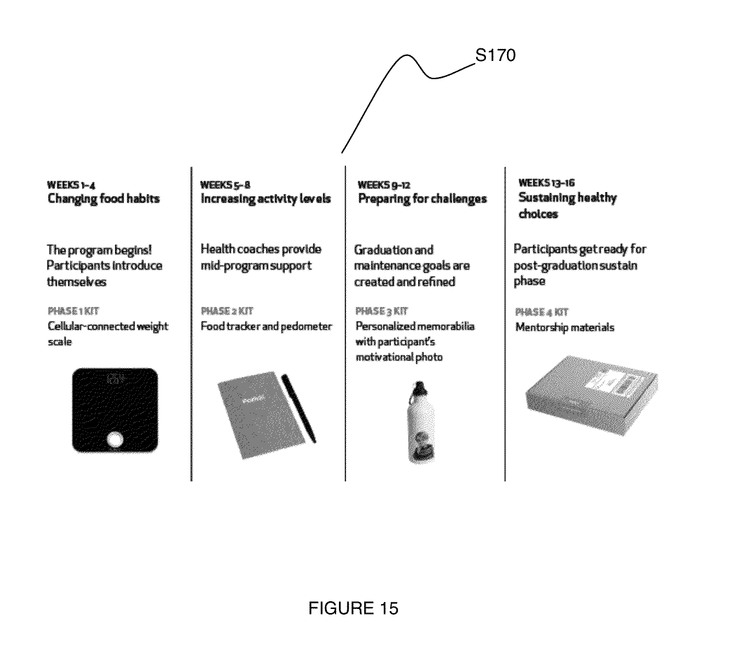

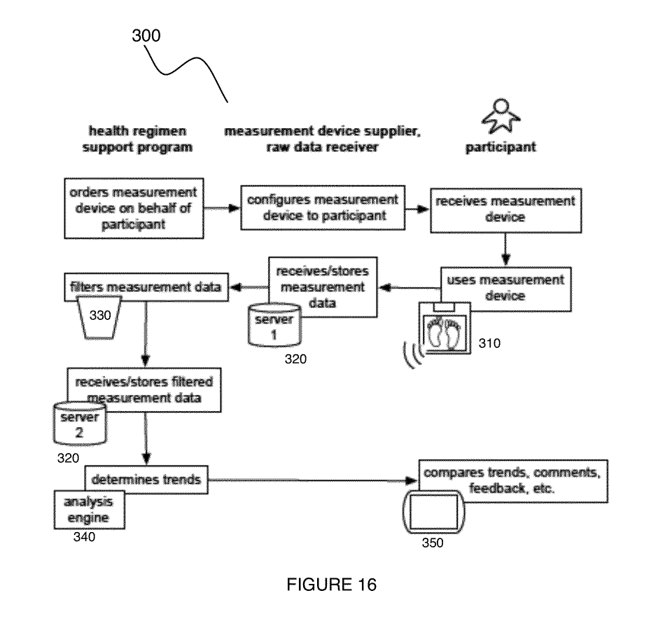

The method 100 may further include providing a health regimen curriculum S170 to each participant of the matched group, which functions to change a participant's eating and activity in order to achieve a goal. In a first example, the health regimen curriculum comprises steps outlined in the Diabetes Prevention Program (a research study funded by the National Institute of Diabetes and Digestive and Kidney Diseases), and providing a health regimen curriculum comprises presenting steps based on the Diabetes Prevention Program as lessons through a user interface. In the first example, as shown in FIGS. 10 and 15, the lessons may be organized into four phases, including: a first phase involving changing food habits, a second phase involving increasing activity levels, a third phase involving preparing for challenges, and a fourth phase involving sustaining healthy choices; furthermore, the participant may be encouraged to set goals and meet milestones, as well as complete assignments (e.g. journal entries, meal experiments) as part of the health regimen curriculum in the first example. The first example providing each of the four phases of lessons may be accompanied by providing a kit corresponding to each phase, wherein the first phase kit comprises a body metric measurement device (e.g. a network-connected weight measurement device), the second phase kit comprises a second measurement device and tool (e.g. a pedometer and a food tracking tool), the third phase kit comprises motivational prizes (i.e. upon graduating from the curriculum), and the fourth phase kit comprises materials to support the participant in sustaining healthy choices (i.e. post-graduation). In a second example, providing a health regimen curriculum S170 may comprise providing a diet modification and exercise routine regimen comprising daily meal plans and exercise tasks geared to treat a diagnosed condition, such as cardiovascular disease or diabetes. In a third example, providing a health regimen curriculum S170 may comprise providing a physical therapy regimen curriculum. In other examples, providing a health regimen curriculum S170 may comprise providing any appropriate health regimen curriculum for a given condition, that is preferably fixed, or alternatively, customizable by a participant, facilitator, or automatically to meet the participant's specific needs. The health regimen may be customizable by a facilitator or automatically, such that if the participant is not making progress at a rate comparable to that of a matched group, the health regimen may give the participant additional feedback and advice so that the participant is given an advantage or “handicap” relative to the matched group. The customized health regimen may be provided based on a performance metric of the participant, such as absolute change in body weight relative to an initial baseline measurement (after a period of time has elapsed from initiation of the regimen) or an unmet goal set by the participant and/or a facilitator.

The method 100 may further include providing a physical motivational incentive to the participant S180, which functions to promote adherence to the health regimen curriculum. Providing a physical motivational incentive to the participant S180 may comprise providing health-related physical awards, such as coupons, nutritional supplements, and/or exercise equipment. In an example, providing a physical motivational incentive to the participant S180 may be performed after the participant has reached a health regimen goal/milestone, or if the participant experiences a quantifiable level of progress above a specified threshold. In an alternative example, providing a physical motivational incentive to the participant S180 may be performed if the participant is not making progress at a rate comparable to that of a matched group, such that the participant is given an advantage or “handicap” relative to the matched group to equalize chances of success relative to the matched group. The physical motivational incentive may be provided based on a performance metric of the participant, such as absolute change in body weight relative to an initial baseline measurement (after a period of time has elapsed from initiation of the regimen) or an unmet goal set by the participant and/or a facilitator.

In some alternative embodiments of the method 100, the method 100 may omit matched groups. For example, displaying feedback may include displaying the trend of a body metric measurement of a participant on the profile page of that participant, but not displaying a trend of the body metric measurement of any other participant or group of participants. By omitting matched groups, a facilitator may be assigned to work one-on-one with a participant, instead of in a group setting.

The FIGURES illustrate the architecture, functionality and operation of possible implementations of methods according to preferred embodiments, example configurations, and variations thereof. In this regard, each block in a flowchart or block diagram may represent a module, segment, portion of code, or method step, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### User Interface for Supporting a Health Regimen

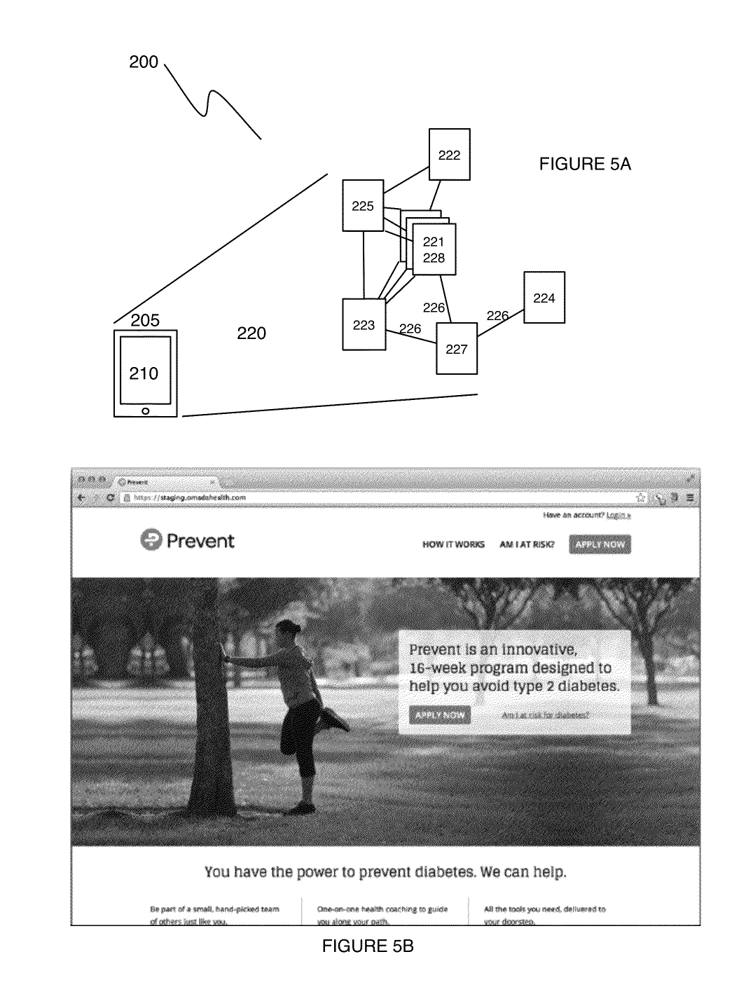

As shown in FIG. 5A, a user interface 200 for supporting a health regimen comprises a networked computing device 205 with a display 210, and an application 220 comprising a plurality of profile pages 221, each profile page corresponding to a respective participant in a first group participating in a health regimen, a progress page 222 accessible by a participant and configured to display health regimen progress of the participant, a first group page 223 corresponding to the first group ad a second group page 224 corresponding to a second group, a curriculum page 225 configured to provide a health regimen curriculum to at least the participant, a message client 226 configured to provide communication between the participant and a second entity, and at least two modes, comprising a facilitator mode 227 and a participant mode 228. The user interface 200 functions to render an interactive environment by which participants in a health regimen may receive peer-based support and facilitator-based support, as well as guidance (in the form of a health regimen curriculum) and/or personalized information regarding health regimen progress. As shown in FIG. 1, the user interface is preferably coupled to a system for supporting a health regimen.

The networked computing device 205 with a display 210 functions to process and render the application 220 for a participant. The networked computing device 205 with a display 210 is preferably a mobile device such as a smart phone, but can alternatively be a tablet, gaming device, laptop, desktop computer, television connected computing device, wearable computing device, or any suitable computing device configured to render and/or display an application. The networked computing device preferably includes an input device capable of detecting gestural input. Preferably, the input device is a touch screen, such that the display 210 also functions as a touch screen, but may alternatively be a cursor positioning device (e.g. a mouse or trackpad), a keyboard, a keypad, or any suitable input device.

The application 220 functions to provide an interface by which a participant and/or a facilitator may receive information regarding health regimen progress of a participant and/or a group of participants, and may interact with another participant in order to provide a source of motivation in support of a health regimen. In a first variation, the application 220 is centrally hosted by one or more servers, and interacts with a plurality of networked computing devices 205 with displays 210, each networked computing device 205 corresponding to a participant. In a second variation, the application 220 is hosted by a distributed system, wherein at least one networked computing device 205 with a display 210 functions as a participant terminal, as a local server, or as both. The application may be a web application accessible through a web browser on a networked computing device 205, or may alternatively be a native application on the networked computing device 205. The application 220 preferably comprises a plurality of profile pages 221, each profile page corresponding to a respective participant in a first group participating in a health regimen, a progress page 222 accessible by a participant and configured to display health regimen progress of the participant, a first group page 223 corresponding to the first group and a second group page 224 corresponding to a second group, a curriculum page 225 configured to provide a health regimen curriculum to at least the participant, a message client 226 configured to provide communication between the participant and a second entity, and at least two modes, comprising a facilitator mode 227 and a participant mode 228.

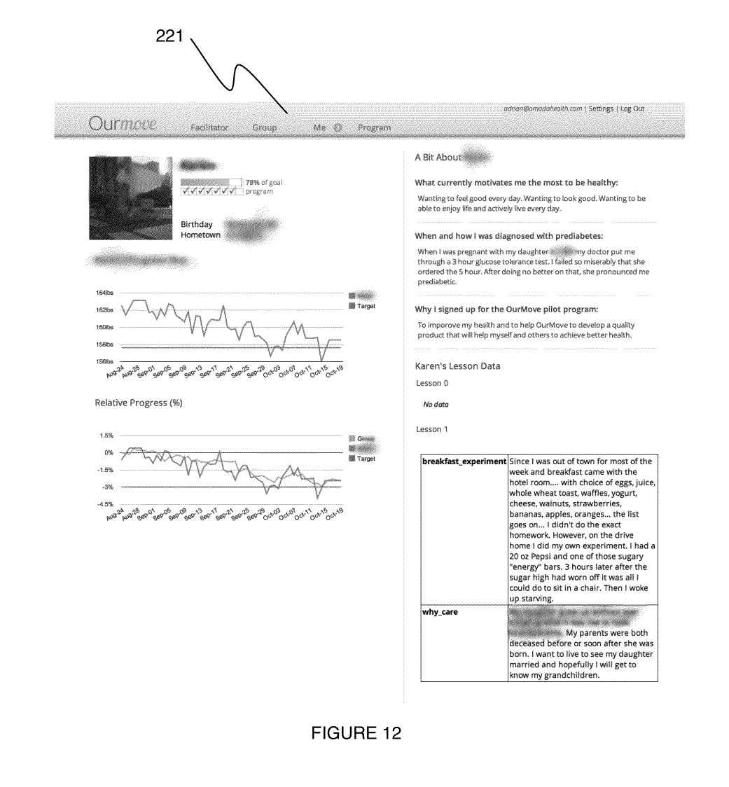

As shown in FIGS. 6 and 12, the plurality of profile pages 221 functions to display details of individual participant progress in a health regimen, as well as personal participant information. Each profile page in the plurality of profile pages 221 preferably displays annotated details of progress achieved by a given participant in the health regimen such as a trend in a body metric measurement of the participant, a trend in a body metric measurement of a participant relative to that of a matched group, and/or a target goal in the health regimen for the participant. Each profile page in the plurality of profile pages 221 may alternatively display non-annotated details of progress achieved by a given participant, or link to a progress page 222 configured to display non-annotated details of progress achieved by a given participant. Each profile page is preferably configured to display biographical information submitted by the given participant, such as motivation for participating in the health regimen program and personalized goals. Each profile page may further be configured to display personal information such as a profile picture, name, summary of progress in the health regimen (e.g. percentage of health regimen program completed), birthday, age, geographical information, occupation, and/or any relevant personal information. Each profile page may enable the given participant corresponding to the profile page to enter additional information related to the health regimen but separate from the body metric measurements received from the measurement device, such as steps walked, meals eaten, answers to questions presented in the health regimen program, and/or any suitable information. Each profile page may also be configured to display images and/or links to profile pages corresponding to other participants in a matched group that comprises the given participant. Additionally, each profile page may comprise a messaging center configured to display messages between the given participant and a facilitator, and/or messages between the given participants and at least one participant of a matched group.

As shown in FIG. 7, the application 220 also comprises a progress page 222 accessible by a participant and configured to display health regimen progress of the participant. The progress page 222 functions to display participant progress in the form of visuals and/or analyzed metrics as a source of motivation for a participant following a health regimen. The progress page 222 is preferably configured to display details and analyses of progress achieved by a given participant in the health regimen such as a trend in a body metric measurement of the participant, a trend in a body metric measurement of a participant relative to that of a matched group, and/or a target goal in the health regimen for the participant. The progress page 222 may be further configured to display overall progress achieved by a participant relative to certain earlier points and/or a starting point, a rate of progress (e.g. body metric change versus time), overall progress achieved by a participant relative to a goal, and/or other personalized biometric data (e.g. current weight, height, age, body mass index). Preferably, the progress page 222 is distinct from a profile page for a participant; however, alternatively, the progress page 222 and profile page for a participant are non-distinct pages.

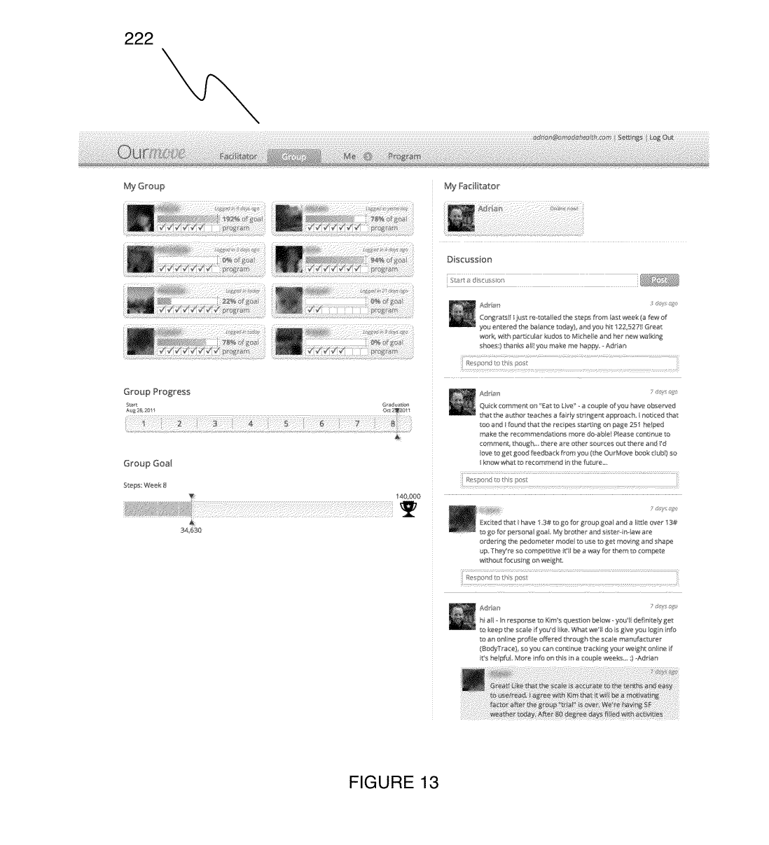

The application 220 also comprises a first group page 223 and a second group page 224 that each function to provide a centralized hub for interactions between participants of a group participating in a health regimen. As shown in FIGS. 8 and 13, a group page 223, 224 preferably displays a list and/or thumbnail summaries of the participants in a group participating in a health regimen, summary information about the progress of the group in the health regimen (e.g. trends and metrics determined from body metric measurement data), and any feedback addressed to the overall group from a facilitator and/or other participants. A group page 223, 224 preferably also comprises links to profile pages of all participants of the group, and may further comprise information regarding the health regimen being followed by participants in the group. In alternative embodiments, a group page 223, 224 may only display a list and/or thumbnail summaries of the participants in a group participating in a health regimen, and links profile pages corresponding to each member in the group participating in a health regimen, as shown in the example of FIG. 8.

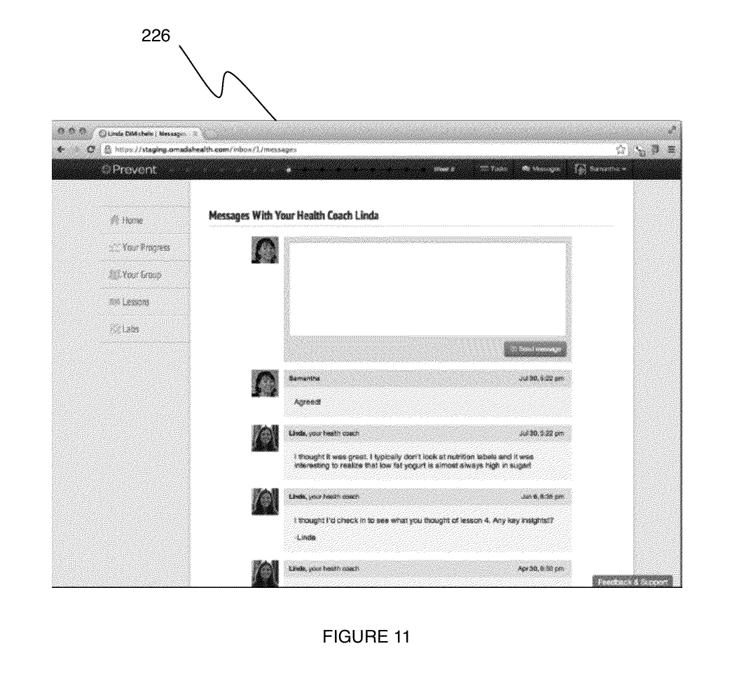

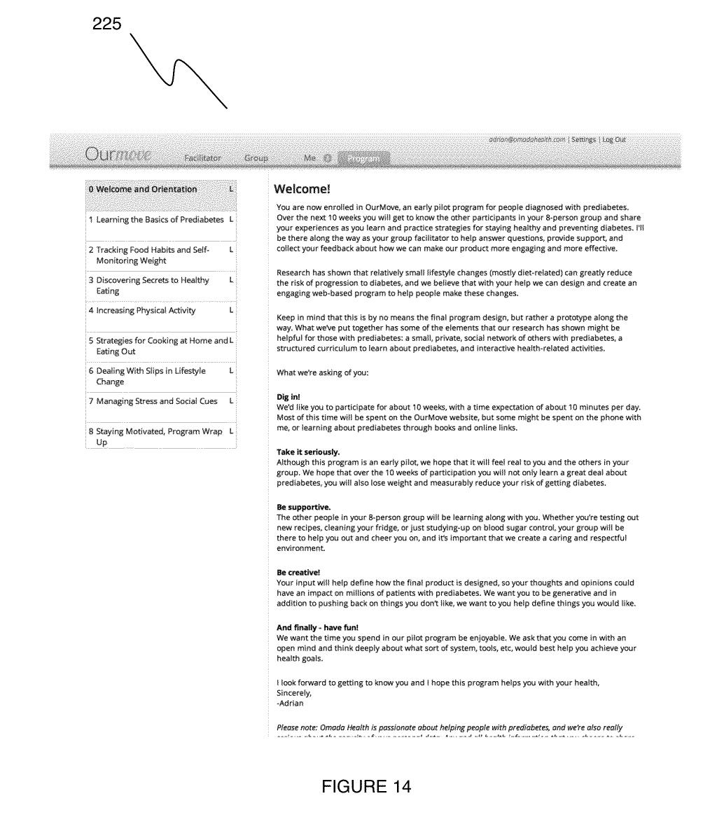

The application 220 also comprises a curriculum page 225 that functions to provide a health regimen curriculum intended to be followed by a participant. The curriculum page 225 preferably outlines steps or other features of a health regimen program. In the preferred embodiment, the curriculum page outlines steps based on the Diabetes Prevention Program (a research study funded by the National Institute of Diabetes and Digestive and Kidney Diseases), but in alternative embodiments, the curriculum page outlines steps or teaches lessons from other alternative health regimens. In an example, as shown in FIG. 14, the curriculum page 225 may include a welcome introduction to the program, tips, guidelines, and/or instructions corresponding to the health regimen program. In another example, as shown in FIG. 11, the curriculum page 225 may alternatively display health regimen tips in the form of a lesson plan, comprising modules, milestones, and/or assignments. Preferably, the curriculum page is configured to display the same curriculum for all participants in a group participating in a health regimen; however, alternatively, the curriculum page may be configured to display a curriculum that is customized to a given participant (e.g. based on participant performance). Preferably, the curriculum page 225 is accessible from a profile page 221, a progress page 222, and a group page 223, 224, but alternatively, the curriculum page 225 is accessible from a subset of a profile page 221, a progress page 222, and a group page 223, 224.

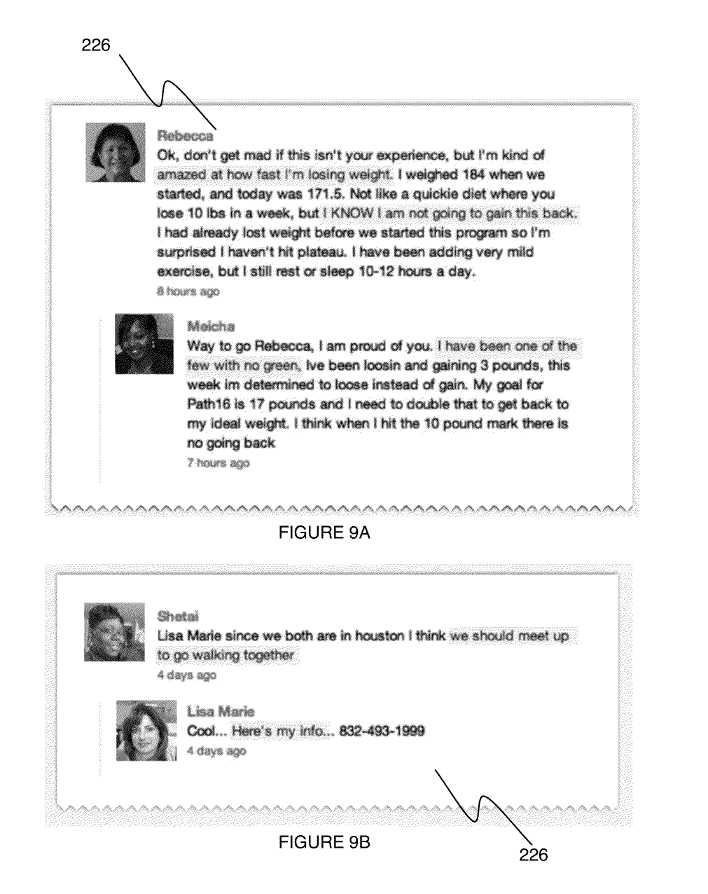

The application 220 also comprises a message client 226 that functions to enable communication between a participant and another entity, facilitated by the user interface. The message client preferably communicates with a server of a message service provider, server of a mailbox service that is a proxy for the message service provider, or any suitable messaging service. The message client preferably enables sending and receiving of messages, and may incorporate messages into a rendered interface. As shown in FIGS. 9A and 9B, the message client 226 may enable communication between a first participant and a second participant. In the example shown in FIG. 9A, a second participant may provide verbal motivational support to a first participant by describing a personal experience while following the health regimen. In the example shown in FIG. 9B, a first participant may connect with a second participant and set up a meeting to perform a task associated with a health regimen curriculum together. Additionally, the message client 226 may enable communication between a participant and a facilitator. In the example shown in FIG. 11, the facilitator may provide advice and motivational support to a participant through the message client 226, in a manner that is only accessible by the participant and the facilitator (i.e. no other participants have access to a communication between the participant and the facilitator). Preferably, either a participant or a facilitator may initiate a participant-facilitator communication by using the message client 226; however, alternatively, only the facilitator may initiate a participant-facilitator communication using the message client 226. The message client preferably also enables communication between more than two entities (e.g. a participant may communicate with at least two other participants, or at least one other participant and a facilitator).

The user interface preferably comprises at least two modes, including a facilitator mode 227 that is activated by a facilitator, and a participant mode 228 that is activated by a participant. The facilitator mode 227 and the participant mode 228 function to provide a facilitator view of the user interface and a participant view of the user interface that is preferably generally more restricted than the facilitator view (except, for example, a particular participant may have an unrestricted view of his or her own profile page), respectively. The facilitator and/or participant modes 227, 228 enable levels of privacy and/or access to respective profile pages of participants. In one example, in the facilitator mode 227 a facilitator of a group may have permission to view a trend in a body metric measurement represented both in percentage change and in absolute numbers, while in a participant mode 228 other participants of the group may be restricted to view only the trend in a body metric measurement represented in percentage change. In a second example, in the facilitator mode 227 a facilitator of a group may have access to all personal and/or biographic information corresponding to each participant in the group he or she facilitates, whereas in participant mode 228 a participant may only have access to his or her own personal and/or biographic information. Such restrictions are preferably set by the participant in a settings portal, as will be understood by one ordinarily skilled in the art. However, the user interface preferably enables each participant to set any suitable privacy and access settings to his profile page or other personal information.

In one embodiment, the facilitator mode 227 may further enable a facilitator to facilitate more than one group (e.g. the first and second group). The facilitator mode may thus comprise an additional facilitator page that enables the facilitator, using the message client 226, to communicate with all groups that the facilitator facilitates. The facilitator mode may enable the facilitator to communicate individually with members of the groups he/she facilitates, or to communicate with an entire group or portion of a group he/she facilitates. In a variation, the facilitator mode 227 may further enable a facilitator to have unrestricted viewing access to all profile pages and group pages corresponding to groups he/she facilitates, but may restrict the facilitator from modifying information displayed on the profile and group pages. In another variation, the facilitator mode 227 may enable a facilitator to have unrestricted viewing access to and the ability to modify all profile pages and group pages corresponding to groups he/she facilitates.

In other embodiments of the user interface 200, the first and second group pages 223, 224 may be further configured to provide a competition between the first group and the second group, in achieving a health regimen goal. In a first variation, a participant of the first group may compete with a portion of the participants of the second group, by accessing at least one of the first and second group pages 223, 224. In a second variation, the entire first group may compete with the entire second group, using at least one of the first and second group pages. Other embodiments of the user interface may incorporate additional pages, such as a home page, as shown in FIG. 5B, and/or functionality in the facilitator and participant modes 227, 228 to further support the health regimen.

### System for Supporting a Health Regimen

A system 300 for supporting a health regimen comprises one or more body metric measurement devices 310 each corresponding to a participant, and configured to transmit a set of body metric measurement data; at least one server 320 configured to receive and store a set of body metric measurement data from the body metric measurement devices; a processor 330 configured to filter the set of body metric measurement data, thus producing a filtered set of body metric measurement data; an analysis engine 340 configured to analyze the filtered set of body metric measurement data and determine a trend in the filtered set of body metric measurement data; and a user interface 350 configured to provide health regimen progress information, a health regimen curriculum, and communication between the participant and a second participant. The system 300 may further comprise The system 300 preferably performs the steps as described in the method for supporting a health regimen and is supported by the user interface 200, which preferably helps foster a supportive community environment that motivates, inspires, and otherwise supports participants as they participate in the health regimen.

As a person skilled in the art will recognize from the previous detailed description and from the figures and claims, modifications and changes can be made to the preferred embodiments of the invention without departing from the scope of this invention defined in the following claims.

We claim:

1. A method for supporting a health regimen comprising:
grouping a plurality of participants into a matched group;
providing, to each participant of the matched group, a body metric measurement device configured to communicate remotely with a network;
receiving a set of body metric measurement data over the network from a participant and a portion of the matched group;
storing the set of body metric measurement data on a server;
determining, based on the set of body metric measurement data, a body metric measurement trend of the participant and a body metric measurement trend of the portion of the matched group; and
providing feedback to the participant based on the body metric measurement trend of the participant relative to the body metric measurement trend of the portion of the matched group.

2. The method of claim 1, further comprising providing a health regimen curriculum to each participant of the matched group.

3. The method of claim 2, wherein providing a health regimen curriculum comprises providing a health regimen curriculum that is customizable to the participant, based upon a performance metric of the participant.

4. The method of claim 2, wherein providing a health regimen curriculum comprises providing a curriculum based upon a diabetes prevention program, wherein providing a health regimen curriculum comprises providing four phases of a diabetes prevention program, including a diet modifying phase, an activity level modifying phase, a graduation phase, and a behavior maintenance phase.

5. The method of claim 1, wherein grouping a plurality of participants into a matched group comprises grouping a plurality of participants into a matched group based on at least one of: a common goal, medical history, a personality trait, a lifestyle characteristic, and personal information.

6. The method of claim 5, wherein grouping a plurality of participants into a matched group comprises a first stage of grouping and a second stage of grouping.

7. The method of claim 1, wherein providing, to each participant of the matched group, a body metric measurement device, comprises providing a body metric measurement device configured to measure body weight.

8. The method of claim 1, further comprising providing, to each participant of the matched group, a second measurement device.

9. The method of claim 1, wherein receiving a set of body metric measurement data over the network from a participant and a portion of the matched group comprises receiving a set of time series of body metric measurement data.

10. The method of claim 9, wherein receiving a set of time series of body metric measurement data comprises receiving a first time series from the participant, and receiving a group of time series, each time series in the group of time series corresponding to a participant of the portion of the matched group.

11. The method of claim 10, wherein receiving a set of time series of body metric measurement data comprises receiving measurement data at regular time intervals from the participant and from each participant of the portion of the matched group.

12. The method of claim 10, wherein receiving a set of time series of body metric measurement data comprises receiving measurement data from the participant and from each participant of the portion of the matched group at substantially equivalent time points.

13. The method of claim 1, wherein storing the set of body metric measurement data comprises filtering the set of body metric measurement data to generate a filtered set of body metric measurement data.

14. The method of claim 13, wherein filtering the set of body metric measurement data comprises identifying an erroneous measurement that deviates from an adjacent measurement by a threshold amount.

15. The method of claim 13, wherein filtering the set of body metric measurement data comprises identifying an erroneous measurement that deviates from a line fitted to a time series in the set of time series by a threshold amount.

16. The method of claim 13, further comprising storing the filtered set of body metric measurement data using a second server.

17. The method of claim 1, wherein determining a body metric measurement trend of the participant comprises determining a difference between a body metric measurement of the participant and an initial baseline body metric measurement of the participant.

18. The method of claim 1, wherein determining a body metric measurement trend of the participant comprises determining a difference between a body metric measurement of the participant and an average of body metric measurements of the participant.

19. The method of claim 1, wherein determining a body metric measurement trend of the participant comprises determining a rate of progress.

20. The method of claim 1, wherein determining a body metric measurement trend of the portion of the matched group comprises determining a trend based on a subset of the set of body metric measurement data, wherein the subset excludes body metric measurements from the participant.

21. The method of claim 1, wherein the portion of the matched group comprises every participant in the matched group.

22. The method of claim 1, wherein determining a trend in the body metric measurement of the portion of the matched group comprises averaging measurements received from each participant of the portion of the matched group.

23. The method of claim 1, wherein providing feedback to the participant comprises displaying the body metric measurement trend of the participant and the body metric measurement trend of the portion of the matched group.

24. The method of claim 1, wherein providing feedback to the participant comprises enabling communication between a facilitator and the participant.

25. The method of claim 1, wherein providing feedback to the participant comprises enabling communication between the participant and a second participant.

26. The method of claim 1, further comprising providing physical motivational incentives to the participant.

27. The method of claim 26, wherein providing physical motivational incentives to the participant is based upon a performance metric of the participant.

28. The method of claim 27, wherein the performance metric is an absolute value of weight loss relative to an initial baseline measurement for the participant.

29. A method for supporting a health regimen comprising:
grouping a plurality of participants into a matched group;
providing, to each participant of the matched group, a health regimen curriculum comprising:
providing, to each participant of the matched group, a first set of lessons and a body metric measurement device configured to communicate remotely with a network,
providing, to each participant of the matched group, a second set of lessons and a second measurement device,
providing, to each participant of the matched group, a third set of lessons, and
providing, to each participant of the matched group, a fourth set of lessons;
receiving a set of body metric measurement data over the network from a participant and a portion of the participants of the matched group;
determining, based on the set of body metric measurement data, a body metric measurement trend of the participant and a body metric measurement trend of the portion of the matched group; and
providing feedback to the participant based on the body metric measurement trend of the participant relative to the body metric measurement trend of the portion of the matched group.

30. The method of claim 29, wherein grouping a plurality of participants into a matched group comprises grouping a plurality of participants into a matched group based on at least one of: a common goal, medical history, a personality trait, a lifestyle characteristic, and personal information.

31. The method of claim 29, wherein providing a first set of lessons and a body metric measurement device comprises providing a set of diet modifying lessons and a weight measurement device.

32. The method of claim 29, wherein providing a second set of lessons and a second measurement device comprises providing a set of activity level modifying lessons and a pedometer.

33. The method of claim 29, wherein receiving a set of time series of body metric measurement data comprises receiving a first time series from the participant, and receiving a group of time series, each time series in the group of time series corresponding to a participant of the portion of the matched group.

34. The method of claim 29, wherein determining a body metric measurement trend of the participant comprises determining a difference between a body metric measurement of the participant and an initial baseline body metric measurement of the participant.

35. The method of claim 29, wherein determining a trend in the body metric measurement of the portion of the matched group comprises averaging measurements received from each participant of the portion of the matched group.

36. The method of claim 29, wherein providing feedback to the participant comprises displaying the body metric measurement trend of the participant and the body metric measurement trend of the portion of the matched group.

37. The method of claim 29, wherein providing feedback to the participant comprises enabling communication between a facilitator and the participant.

38. The method of claim 29, wherein providing feedback to the participant comprises enabling communication between the participant and a second participant.

39. A system for supporting a health regimen comprising:
a server configured to receive and store a set of body metric measurement data from a set of body metric measurement devices, corresponding to a group of participants;
a processor configured to filter the set of body metric measurement data, thus producing a filtered set of body metric measurement data;
an analysis engine configured to
determine a trend in the filtered set of body metric measurement data for a participant of the group of participants,
and determine a trend in the filtered set of body metric measurement data for a portion of the group of participants; and
a user interface configured to provide health regimen progress information, a health regimen curriculum, and communication between the participant and a second participant.

40. The system of claim 39, wherein the processor is configured to receive the set of body metric measurement data from the server.

41. The system of claim 39, wherein the set of body metric measurement devices comprises a weight scale configured to communicate remotely with the system.

42. The system of claim 39, wherein the processor is configured to filter the set of body metric measurement data by identifying an erroneous measurement that deviates from an adjacent measurement by a threshold amount.

43. The system of claim 39, further comprising a second server configured to receive the filtered set of body metric measurement data.

44. The system of claim 39, wherein the analysis engine is configured to determine a trend in the filtered set of body metric measurement data for a participant by determining a difference between a body metric measurement of the participant and an initial baseline body metric measurement of the participant.

45. The system of claim 39, wherein the analysis engine is configured to determine a trend in the filtered set of body metric measurement data for a portion of the group of participants by averaging measurements received from each participant of the portion of the matched group.

46. The system of claim 39, wherein the user interface is further configured to render the trend for the participant and the trend for the portion of the group of participants.

47. The system of claim 39, wherein the user interface is further configured to provide communication between the participant and a facilitator.
